(19) United States
(12) Patent Application Publication
(10) Pub. No.: US 2015/0377436 A1
(43) Pub. Date: Dec. 31, 2015

(54) LAMP DESIGN METHOD FOR AUTOMOBILE

(71) Applicant: HYUNDAI MOBIS CO., LTD., Seoul (KR)

(72) Inventor: Hyuk Min LEE, Yongin (KR)

(21) Appl. No.: 14/677,785

(22) Filed: Apr. 2, 2015

(30) Foreign Application Priority Data
Jun. 30, 2014 (KR) 10-2014-0080724

(51) Int. Cl. F21S 8/10

(52) U.S. Cl. CPC F21S 48/00; F21Y 2101/02

(57) ABSTRACT

The present invention relates to a lamp design method for an automobile. The present invention makes functions of a pitch between light sources and an air gap to be applied to the design in order to improve light uniformity. The present invention may suggest an optimal design method of an FDT surface light source lamp.

### CROSS-REFERENCE TO RELATED APPLICATIONS

This application claims priority to and the benefit of Korean Patent Application No. 10-2014-0080724 filed in the Korean Intellectual Property Office on Jun. 30, 2014, the entire contents of which are incorporated herein by reference.

### TECHNICAL FIELD

The present invention relates to a lamp design method for an automobile, and more particularly, to a lamp design method for an automobile which suggests an optimal design method of an FDT surface light source lamp.

### BACKGROUND ART

Generally, a light emission method of an automobile lamp may be divided into a reflective type or an indirect type which has a general structure and a direct type which has a fluorescent discharge tube (FDT) structure.

In the case of a reflective type or an indirect type as illustrated in FIG. 1, in a light source 10, such as an LED, due to secondary reflection, light loss may occur, light efficiency is reduced, and many LEDs are required while improving light uniformity. However, in the case of the direct type as illustrated in FIG. 2, the light source 10 such as an LED emits light without reflecting the light, so that light uniformity is increased and the number of LEDs is reduced.

Since a design method which may improve the light uniformity of the FDT surface light source has currently progressed through a number of trial and error, lots of labors and a lot time are allocated so that a method for a mathematized optimal lamp design for an automobile which may solve the above-mentioned technical problems is acutely demanded.

### SUMMARY OF THE INVENTION

The present invention has been made in an effort to provide a lamp design method for an automobile which may suggest an optimal design method of an FDT surface light source lamp.

An exemplary embodiment of the present invention provides a lamp design method for an automobile, in which functions of a pitch between light sources and an air gap are combined and applied to a design in order to improve light uniformity.

The pitch may be 50 to 80 mm.

The air gap may be 20 to 40 mm.

Light uniformity=0.962046+0.00623107×(air gap)−0.00444847×(pitch).

The uniformity of the light source may be applied to light uniformity of an LED direct type surface light source.

According to the lamp design method for an automobile according to the present invention, a lamp design method for an automobile which may suggest an optimal design method of an FDT surface light source lamp may be provided.

Uniformity may be improved and the number of LEDs may be reduced.

The number of trial and error required for improving light uniformity of an FDT surface light source may be significantly reduced.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a view illustrating a direct type or an indirect type light source emitting method of a related art.

FIG. 2 is a view of a direct type light source emitting method of the related art.

FIG. 3 is a view illustrating a pitch between light sources and an air gap according to an exemplary embodiment.

FIG. 4 is a view illustrating a contour plot of uniformity vs. an air gap and a pitch according to an exemplary embodiment.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Currently, a design method which may improve light uniformity of an FDT surface light source has been progressed through the number of trial and error so that lots of labors and times are allocated. The present invention provides a method for a mathematized optimal lamp design for an automobile which may solve the above-mentioned technical problems.

Hereinafter, a lamp design method for an automobile according to the present invention will be described with reference to accompanying drawings.

FIG. 3 is a view illustrating a pitch between light sources and an air gap according to an exemplary embodiment. Referring to FIG. 3, the light uniformity of the FDT is a function of a pitch between LEDs and an air gap. In order to improve a specific light uniformity, variables of the pitch P and the air gap C need to be appropriately combined. By the correlation, the light uniformity may be improved and the number of light sources 10 such as LED may be reduced. The present invention positively verifies the correlation and suggests a mathematical model.

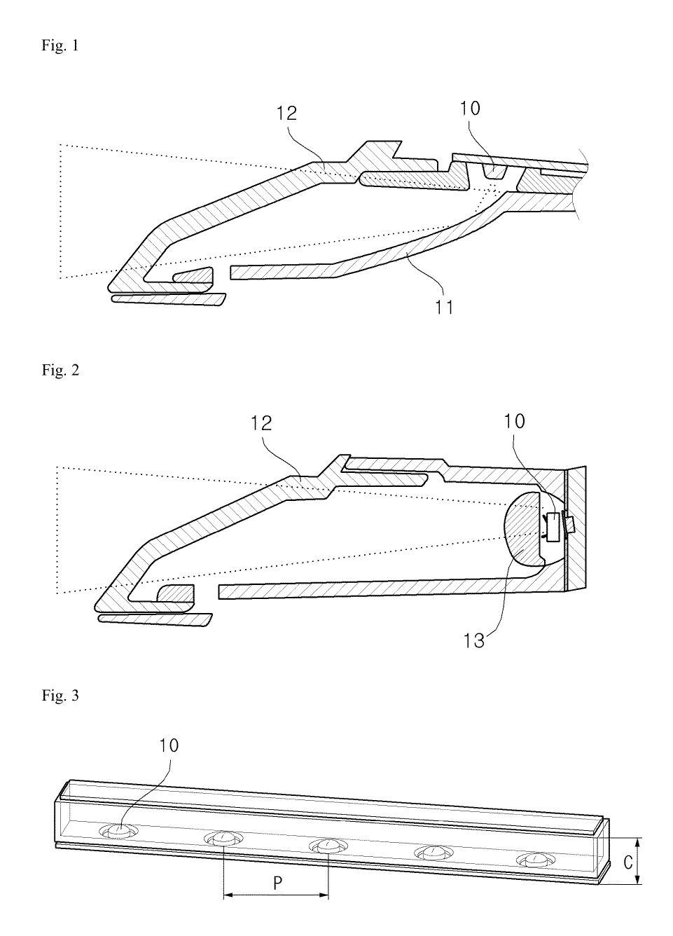

According to the exemplary embodiment of the present invention, functions of a pitch P between the light sources 10 and an air gap C which are variables for improving light uniformity are combined to be applied to the design. Specifically, referring to FIG. 1, the pitch P, which is a distance between the light sources 10 such as LEDs, is designed to be 50 to 80 mm and the air gap C, which is a height of an inside of a cover in which the light source 10 is provided, is designed to be 20 to 40 mm.

The light uniformity may be expressed by the following equation.

Light uniformity=0.962046+0.00623107×(air gap)−0.00444847×(pitch). Equation 1

The “air gap” and the “pitch” are variables. “20 to 40 mm” is substituted as a value of the “air gap”, as described above. “50 to 80 mm” is substituted as a value of the “pitch”, as described above. The light uniformity may be applied to light uniformity of a direct type surface light source such as an LED. Except for the “air gap” and the “pitch” in the equation for the light uniformity, the values of “0.962046”, “0.00623107”, and “0.00444847” are fixed values. The fixed values may be set data values or values obtained by an experiment.

When a specific uniformity demanding specification is fixed by original equipment manufacturing (OEM), the light uniformity may satisfy a desired demanding specification by adjusting the pitch P and the air gap C.

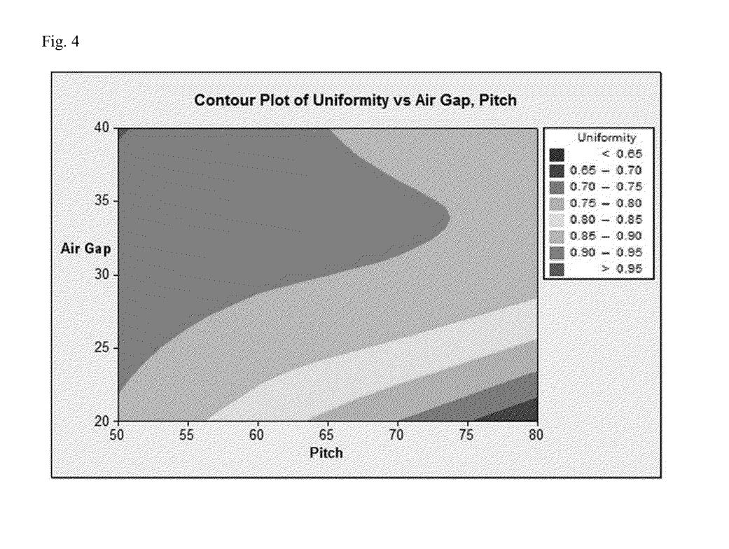

FIG. 4 is a view illustrating a contour plot of uniformity vs. an air gap and a pitch according to an exemplary embodiment. As illustrated in FIG. 4, the pitch P and the air gap C may be illustrated on a contour plot.

As described above, the lamp design method for an automobile according to an exemplary embodiment of the present invention may provide a mathematized optimal lamp design method of an FDT surface light source lamp. Further, uniformity may be improved and the number of LEDs may be reduced. Further, the light uniformity is mathematized so that a data value of the light uniformity is easily calculated only by substituting variables of the “pitch” and the “air gap”, which are set as values in a predetermined range, in any cases, thereby significantly reducing trials and errors for improving the light uniformity of the FDT surface light source.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A lamp design method for an automobile, wherein functions of a pitch between light sources and an air gap are combined and applied to a design in order to improve light uniformity.

2. The lamp design method of claim 1, wherein: the pitch is 50 to 80 mm.

3. The lamp design method of claim 2, wherein the air gap is 20 to 40 mm.

4. The lamp design method of claim 3, wherein Light uniformity=0.962046+0.00623107×(air gap)−0.00444847×(pitch).

5. The lamp design method of claim 1, wherein the uniformity of the light source is applied to light uniformity of an LED direct type surface light source.
